(19) United States
(12) Patent Application Publication
(10) Pub. No.: US 2014/0153999 A1
(43) Pub. Date: Jun. 5, 2014

(54) RESTRICTED BALL JOINT

(71) Applicants: Eric Holmes, Ann Arbor, MI (US); Markus Fischer, Steinfeld (DE); William Ryan, Farmington Hills, MI (US)

(72) Inventors: Eric Holmes, Ann Arbor, MI (US); Markus Fischer, Steinfeld (DE); William Ryan, Farmington Hills, MI (US)

(21) Appl. No.: 13/693,682

(22) Filed: Dec. 4, 2012

(51) Int. Cl. F16C 11/06

(52) U.S. Cl. CPC F16C 11/06
USPC 403/134; 403/122; 403/135

(57) ABSTRACT

A restricted ball joint may include a passage that has a sidewall, which restricts the oscillation of the ball joint by restricting the range of motion of a shaft or stud that extends at least partially into the passage and makes contact with the sidewall when the ball joint is at a point of maximum oscillation. The ball joint may be restricted in one, two, or three axes. Restricting the ball joint in one or more axes may reduce stress on the ball joint due to flop because the loading of a vehicle tie rod may be carried by the neck of the shaft or by a stud extending from the ball shaft away from the stud when the passage is located opposite the shaft.

### BACKGROUND OF THE INVENTION

1. Field of the Invention

The invention relates to ball joints. In particular, the invention relates to ball joints used in vehicle suspensions.

2. Related Art

Ball joints connect two mechanical members together and provide a range of angular motion, or oscillation, of one member compared to the other. A ball joint generally consists of a ball head connected to a ball shaft and a housing that encloses the ball head. Typically, the housing includes a circular opening for the ball shaft that allows the ball head assembly to rotate within the housing. By convention, the ball shaft is at zero degrees of oscillation when the axis of the ball shaft is centered on the semisphere of the ball head that is exposed by the opening in the housing. Depending on the size of the opening, the ball shaft may oscillate such that the axis of the ball shaft draws a circle that moves through its maximum range of motion as permitted by the opening in the housing. The angle of oscillation is measured based on the total range that the ball shaft may move from zero degrees until its motion is prevented by the edge of the opening. The total angle of oscillation may be, for example, 30 degrees in each direction.

In many vehicle steering and suspension systems, a tie rod links together the vehicle's steering rack and wheel knuckles by way of two or more ball joints. The housing of the ball joints may be connected to the tie rod of a vehicle or an intermediate linkage between the housing and the tie rod. The ball shaft may be connected to the wheel knuckle. The ball joint thus allows for freedom of movement in multiple directions to accommodate movement caused by the wheel knuckles as they rotate and the wheels as they roll over bumps and potholes in the road.

Over time, the components of a vehicle's steering and suspension system may become worn. Eventually, the tie rod may begin to flop in a vertical direction with respect to the road. Although the tie rod should be able to move in the vertical direction to some limited extent, for example, due to the vehicle's shock absorbers, the tie rod should move mostly in a lateral direction with respect to the road. Tie rod flop may occur when the tie rod moves in a vertical direction and the pivot point of the movement is the ball joints. Excessive tie rod flop may result in reduced steering response, poor handling, and loud clanking and knocking noises. These adverse effects may decrease the safety and comfort of the vehicle. Thus, there is a need for a ball joint that may reduce tie rod flop.

### SUMMARY OF THE INVENTION

The descriptions below include apparatuses for restricting the oscillation of a ball joint. A restricted ball joint may include a housing with an opening defined by a first curve, a second curve, and a sidewall having an area between the first and second curves. The maximum oscillation of the ball joint may be restricted by the sidewall in one or more directions of movement. The restricted ball joint may result in reduced tie rod flop because the sidewall may restrict movement of the ball joint and the tie rod connected to it in the direction of the flop.

According to one embodiment of the invention, a ball joint comprises a housing that comprises an inner surface an outer surface, and a passage extending at least through the inner surface; a ball head rotatably fitted within the inner surface; and a member connected to, and extending axially from, the ball head at least partially through the passage, the passage comprising: a sidewall defined by a first curve proximate to the ball head, a second curve distal from the ball head, and an area between the first curve and the second curve, wherein the first curve and the second curve are non-circular and differently sized.

According to another embodiment of the invention, a ball joint comprises a housing; a ball head rotatably fitted within the housing; and a shaft connected to, and extending axially from, the ball head through an opening in a first end of the housing, the opening comprising: a sidewall defined by a first curve proximate to the ball head, a second curve distal from the ball head, and an area between the first curve and the second curve, wherein the first curve and the second curve are non-circular and differently sized.

According to another embodiment of the invention, a ball joint comprises: a housing; a ball head rotatably fitted within the housing; a shaft connected to, and extending axially from, the ball head through an opening in a first end of the housing; and a stud connected to, and extending axially from, the ball head, and extending axially from the ball head at least partially into a channel, the channel formed by a sidewall; wherein the sidewall is defined by a first curve proximate to the ball head, a second curve distal from the ball head, and an area between the first curve and the second curve, and wherein the first curve and the second curve are non-circular and differently sized.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The embodiments described below may be more fully understood by reading the following description in conjunction with the drawings, in which

FIG. 1 is a drawing of a passage for a ball joint according to one embodiment of the invention;

FIG. 2 is a diagram of curves that define a passage for a ball joint according to one embodiment of the invention;

FIG. 3 is a drawing of a ball joint according to one embodiment of the invention;

FIG. 4 is a drawing of a ball joint according to one embodiment of the invention;

FIG. 5 is a drawing of a ball joint component according to one embodiment of the invention;

FIG. 6 is a drawing of a ball joint according to one embodiment of the invention;

FIG. 7 is a drawing of a ball joint according to one embodiment of the invention;

FIG. 8 is a drawing of a ball joint housing according to one embodiment of the invention;

FIG. 9 is a drawing of a ball race according to one embodiment of the invention;

FIG. 10 is a drawing of a ball joint according to one embodiment of the invention;

FIG. 11 is a drawing of a ball joint housing according to one embodiment of the invention;

FIG. 12 is a drawing of a ball joint housing according to one embodiment of the invention;

FIG. 13 is a drawing of a ball joint according to one embodiment of the invention;

FIG. 14 is a side cutaway perspective of a ball joint according to one embodiment of the invention;

FIG. 15 is a side cutaway perspective of a ball joint according to one embodiment of the invention; and

FIG. 16 is a drawing of a passage for a ball joint according to one embodiment of the invention.

### DETAILED DESCRIPTION

The described embodiments provide for a restricted ball joint that is restricted from oscillating in one or more directions. The restriction may be complete in that the ball joint may be restricted from oscillating entirely in a particular direction. Or, the restriction may be partial, in that the ball joint may be restricted to oscillating less in one direction than in another direction. A restricted ball joint may include a passage with a sidewall such that a member connected to the ball head is restricted from oscillating in certain directions by the sidewall as the ball head rotates within the housing. The sidewall may be defined by a first curve proximate to the ball head, a second curve distal to the ball head, and the area between the first and second curve. This area may be a contoured surface that serves as the sidewall. The member and ball head is prevented from rotating within the ball joint housing by the sidewall as the member makes contact with the sidewall. Thus, the ball joint's ball shaft may be restricted from oscillating in a particular direction because of the shape of the sidewall.

The described embodiments may alleviate flop that occurs when a tie rod rattles in a vertical direction. The restricted ball joint may prevent flop by restricting the components connected to the ball joint, for example, the wheel knuckle and the tie rod, from moving in a particular direction with respect to one another. The same restricted ball joint may allow the same components to move in a different direction with respect to one another.

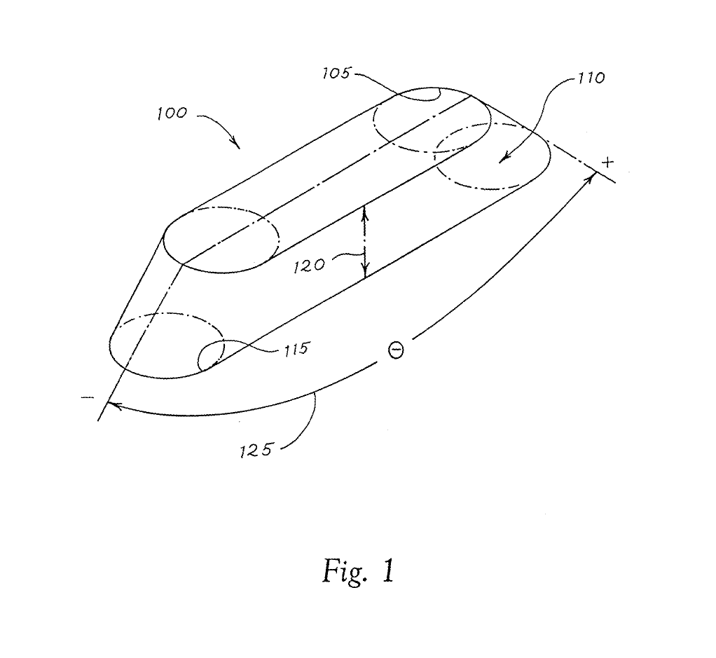

FIG. 1 illustrates a drawing of passage 100 that may be part of a restricted ball joint. The shape of passage 100 is defined by sidewall 110. Sidewall 110, in turn, is defined by curve 105, curve 115, and the area between curves 105 and 115. The area is dependent on the distance between curves 105 and 115. In passage 100, curves 105 and 115 lie in parallel planes. Distance 120 is the distance between the parallel planes that contain curves 105 and 115. Alternatively, curves 105 and 115 may lie in non-parallel planes, or, curve 105 and/or curve 115 may be non-planar. Surface 110 restricts the maximum oscillation of the ball joint by prohibiting a member, for example, a ball shaft or a ball stud, from moving past a certain angle of rotation. Angle 125, represented by θ, depicts the total maximum oscillation permitted by passage 100. Passage 100 may provide an asymmetrical restriction for the oscillation range of angle 125. The maximum oscillation in the direction towards the “−” from zero degrees (i.e., perpendicular to the planes of curves 105 and 115) may be greater than the maximum oscillation in the direction towards the “+” from zero degrees. The maximum oscillation of a ball joint may be asymmetrical in all or some directions of movement. Alternatively, the maximum oscillation of a ball joint may be symmetrical in all or some directions of movement.

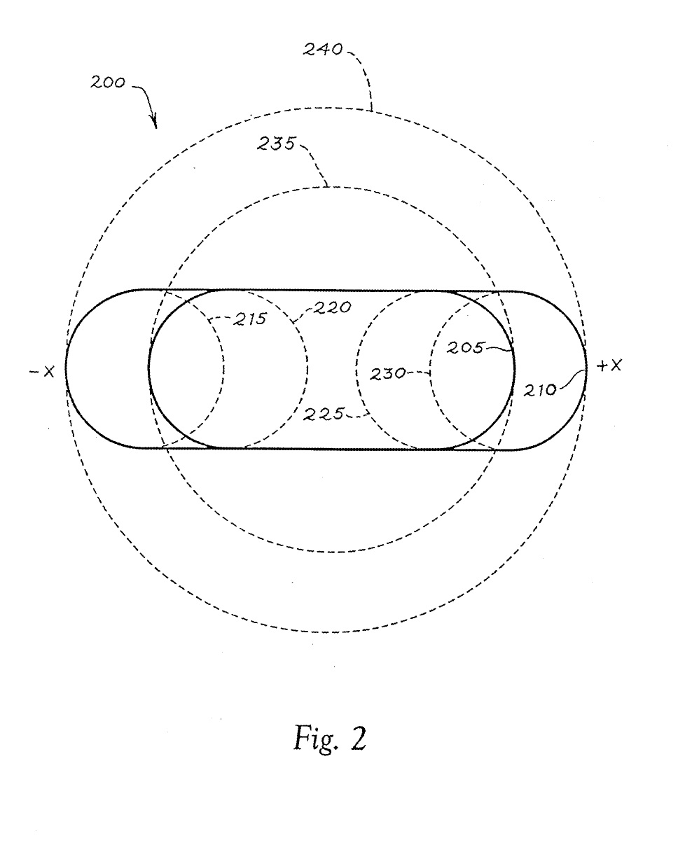

FIG. 2 illustrates a two-dimensional drawing of a three-dimensional passage 200 that may be part of a restricted ball joint. Passage 200 is defined by curve 205, curve 210, and the area between the curves 205 and 210. The area is not depicted in FIG. 2 because passage 200 is drawn in two dimensions. Curve 205 is defined by curves 220, 225, and 235. Curve 210 is defined by curves 240, 215, and 230. In FIG. 2, curves 220, 225, 235, 240, 215, and 230 are circles. Alternatively, curves 220, 225, 235, 240, 215, and 230 may be non-circular. Passage 200 provides for symmetrical maximum oscillation in direction from “−x” to “+x.” Passage 200 may be used in a ball joint to restrict oscillation. Passage 200, for example, may define the opening of a ball joint that accommodates a ball shaft, which is connected to the ball head. In this example, passage 200 would prevent the ball shaft from moving in any direction other than from “−x” to “+x.” Thus, passage 200 may restrict the ball joint to a maximum oscillation of “2x.”

Alternatively, for example, passage 200 may define a channel or opening that is on the opposite side of the housing from the opening that accommodates the ball shaft. In this example, passage 200 may accommodate a ball stud that is connected to, and extending axially from, the ball head. Passage 200 restricts the ball joint by preventing the stud from moving any direction other than from “−x” to “+x.” Thus, passage 200 may restrict the ball joint to a maximum oscillation of “2x.”

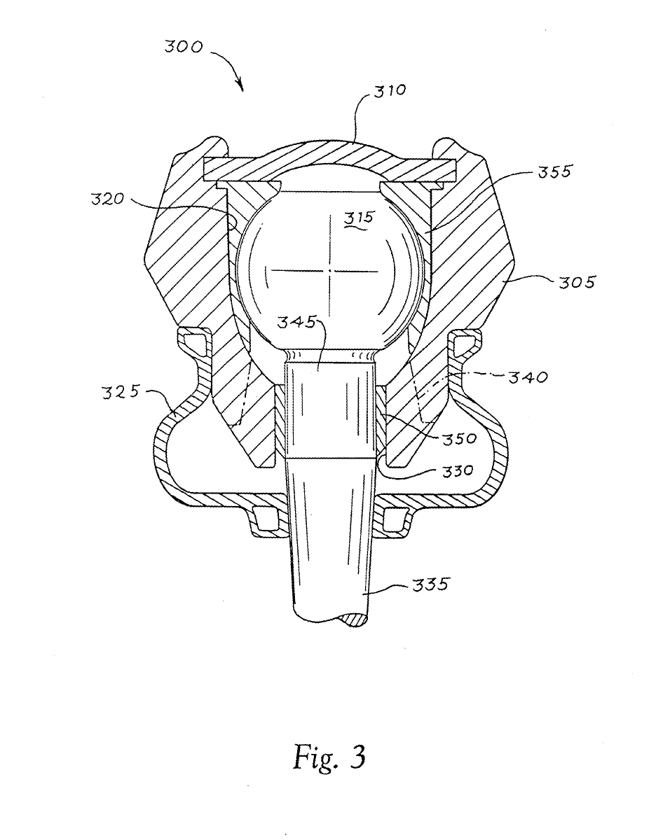

FIG. 3 illustrates a mechanical drawing of ball joint 300. Ball joint 300 comprises housing 305, cap 310, ball head 315, and ball shaft 335. Housing 305 partially encloses ball head 315. Ball race 355 is fitted between inner surface 320 of housing 305 and ball head 315. Ball race 355 may be a slotted design to more easily fit over the ball head upon installation. The slots of ball race 355 may form petals or sections of ball race 355 that allow ball race 355 to spread open during installation, and then close again when installation of ball race 355 is complete. Alternatively, a ball race may be omitted, and ball head 315 may be rotatably fitted inside inner surface 320 of housing 305. Lubricants such as grease, graphite, or oil may be used to lubricate the interface between ball head 315 and ball race 355. If a ball race is not used, then lubricant may be used to lubricate the interface between ball head 315 and inner surface 320.

Housing 305 may also comprise a means to attach ball joint 300 to another component, for example, a tie rod. For example, a threaded rod may be attached to housing 305. The threaded rod may then connect to a tie rod or a mechanical linkage.

Cap 310 is fitted over ball head 315 and ball race 335. Cap 310 may effectively hold ball head 315 and ball race 355 in place. Alternatively, housing 305 may be formed from two halves such that ball head 315 and ball race 335 may be fitted in one halve of housing 305 before the two halves are joined. Thus, in that alternative, a cap may not be necessary.

Ball head 315 may be composed of steel or other suitable metal or material. Ball shaft 335 extends axially from ball head 315. Ball shaft 315 may be integral to ball head 315 and formed from the same material. Alternatively, ball shaft 335 may be a separate component that is attached to ball head 315. For example, ball head 315 may be designed to accept a threaded ball shaft. Ball shaft 335 may also be a composite of materials. For example, ball shaft 335 may be formed primarily from steel, but may include acetal bearing material at neck 345. Neck 345 is a region of ball shaft 335 that makes contact with the passage having sidewall 330 formed in housing 305. Ring 350 may be fitted around neck 345. Ring 350 may be composed of a material suitable to withstand friction between ring 350 and sidewall 330. For example, ring 350 may be composed of steel, bronze, an acetal bearing material, or plastic, for example, polyether ether ketone (“PEEK”). Ring 350 may advantageously reduce noise created by the friction between ring 350 and sidewall 330. Ring 350 may also be sized to alter performance of the ball joint. A larger-sized ring 350 may further restrict the maximum oscillation of the ball joint.

Ball joint 300 may include seal 325. Seal 325 may form a seal around the housing 305 and ball shaft 335. Seal 325 may advantageously prevent dirt, moisture, or other contaminants from entering the passage formed by sidewall 330. Such contaminants may decrease the performance and lifetime of ball joint 300. Seal 325 may be rubber or some other flexible material that resists dirt, moisture, or other contaminants.

Ball joint 300 may be installed in a vehicle's steering and suspension system. During operation of the vehicle, i.e., when the vehicle is being driven along a road, ball joint 300 may allow two components in the steering and suspension system to move with respect to one another in one direction, while restricting movement of the components with respect to one another in another direction. This may be accomplished by sidewall 330 because the shape of sidewall 330 may be design so that neck 345 is prevented from oscillating in one direction but is free to oscillate in another direction. The restriction in one direction may be accomplished by forming sidewall 330 such that it is non-circular. For example, sidewall 330 may be defined by two ovals, one larger than the other. The smaller oval may be closer to ball head 315 so that the sidewall is slanted as depicted by line 340. A slant in sidewall 330 may provide a greater surface area for neck 345 to contact. This configuration of a non-circular sidewall restricting the oscillation of ball joint 300 may result in an improved ball joint that reduces flop in the vehicle's steering and suspension system, particularly tie rod flop.

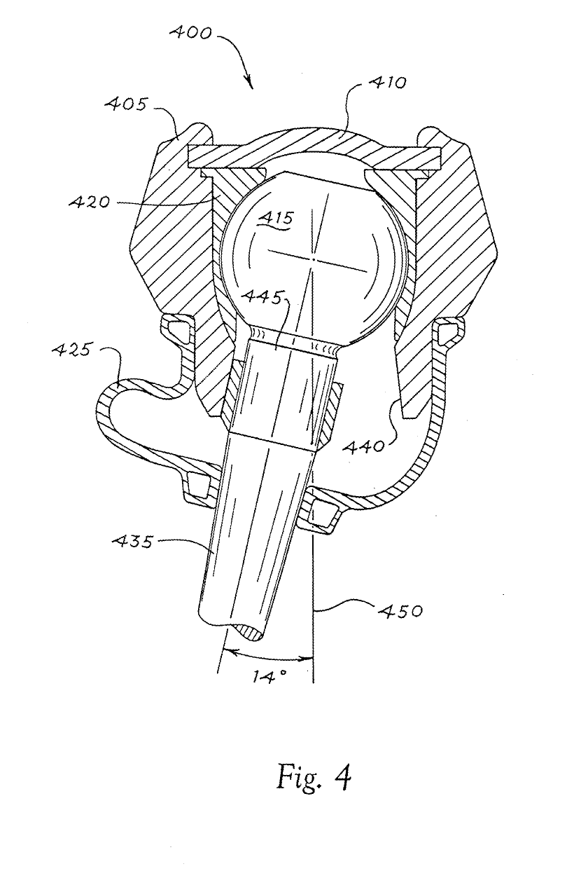

FIG. 4 depicts ball joint 400, which includes housing 405 and cap 410. Within housing 405 is ball race 420, and fitted within ball race 420 is ball head 415. Ball race 420 may be any suitable material such as steel or plastic, for example, PEEK. Ball race may advantageously increase the lifetime of ball joint 400 because it may absorb forces by ball head 415 on housing 405. Ball race 420 may also be replaceable. Ball joint 400 may have seal 425, which may advantageously prolong the lifetime of ball joint 400 be preventing dirt, moisture, or other contaminants from entering ball joint 400, specifically the passage formed by sidewall 440.

The movement of neck 445, which is the neck of ball shaft 435, may be restricted by sidewall 440. Thus, ball joint 400 may have a restricted maximum oscillation in one or more directions. The restriction may be dependent on the angle of sidewall 440 from axis 450. The larger the angle formed by the slant of 440 and axis 450, the greater the maximum oscillation of the ball joint in the plane of the drawing in FIG. 4. In this configuration, sidewall 440 restricts the maximum oscillation of ball joint 400. This configuration may result in an improved ball joint that reduces flop in the vehicle's steering and suspension system, particularly tie rod flop, because ball joint 400 may prevent movement in one plane, but permit movement in another plane. If sidewall 440 is defined by non-circular curves, then the oscillation of ball joint 400 may be restricted by different amounts in different planes of oscillation of ball joint 400.

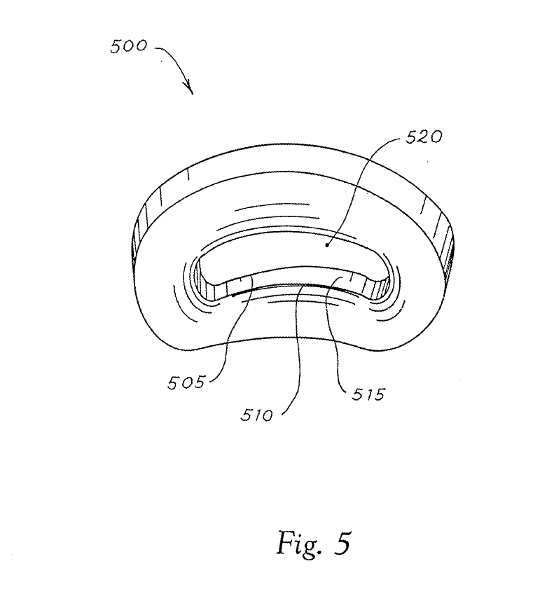

FIG. 5 depicts ball joint component 500. Ball joint component 500 may be fitted as a cap to the housing in a ball joint. Alternatively, ball joint component 500 may be formed at the base of a ball joint, and/or may be integral to the ball joint. Ball joint component 500 has passage 520. If ball joint component is used as a cap for a ball joint, then passage 520 is a channel or groove, i.e., passage 520 is not a hole in ball joint component 500 and passage 520 does not permit another component to pass through passage 500. Passage 520 may allow another component to partially pass into passage 520. Alternatively, passage 520 is an opening that allows a component to pass through. For example, passage 520 may allow a ball shaft connected to a ball head to pass through passage 520 to be connected to another component.

Passage 520 is defined by sidewall 515. The area between curves 505 and 510 defines sidewall 515. Sidewall 515 may be advantageously used to restrict the maximum oscillation of a ball joint in certain planes. More particularly, sidewall 515 may restrict the maximum oscillation by different amounts in different directions. For example, sidewall 515 may restrict the oscillation of a ball joint entirely in a first direction, and may permit ±15 degrees of oscillation in a second direction, where the first direction is perpendicular to the second direction.

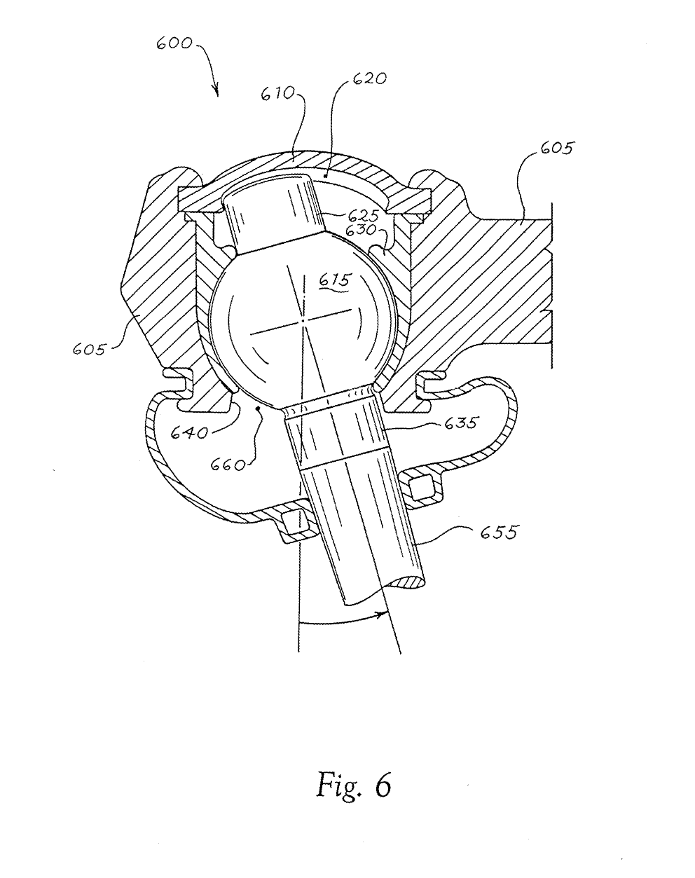

FIG. 6 depicts ball joint 600. Housing 605 encloses ball head 615. Ball race 630 is optional and may be fitted between housing 605 and ball head 615. Cap 610 encloses ball head 615 from the top end of ball joint 600. Cap 610 includes channel 620, which may be a groove that is milled or formed into cap 610. Channel 620 may be dimensioned such that it is longer than it is wide. Channel 620 permits ball stud 625 to extend partially into channel 620. Ball stud 625 is connected to ball head 615. The width of channel 620 may be slightly larger than the diameter of ball stud 625, for example, larger by 1/16^{th} of an inch. The length of channel 620 may be larger than the diameter of ball stud 625, for example, two times larger. In this example, ball stud 625 may travel back and forth in channel 620, but may not travel side to side (i.e., in a direction perpendicular to back and forth) because the width of channel 620 does not permit more than 1/16^{th} inch movements, which may be negligible in a given application. Thus, cap 610 with channel 620 restricts the maximum oscillation of ball stud 625 and for ball joint 600.

Housing 605 has opening 660 at the bottom end through which ball shaft 655 passes. Ball shaft 655 may be integral to ball head 615, or may be attached to ball head 615, for example, with threading or by welding. Ball joint 600 may include sidewall 640 formed in housing 605. Sidewall 640 defines opening 660 through which ball shaft 655 passes. Neck 635 may make contact with sidewall 640 when ball joint 600 is at maximum oscillation. Sidewall 640 may be formed such that it restricts ball joint 600 to a particular maximum oscillation. For example, sidewall 640 may permit ball shaft 655 (and therefore ball joint 600) to oscillate ±15 degrees from left to right, and sidewall 640 may restrict ball shaft 655 (and therefore ball joint 600) from oscillating all but a very small amount, for example, less than ±0.2 degrees, or within the manufacturing tolerances of ball joint 600, in a direction perpendicular to the plane of the drawing in FIG. 6.

Sidewall 640 and channel 620 may be advantageously sized such that sidewall 640 restricts ball shaft 655 by the same amount as channel 620 restricts ball stud 625. This may result in two surfaces—sidewall 640 and the side of channel 620—that bear the forces on ball shaft 655 at maximum oscillation.

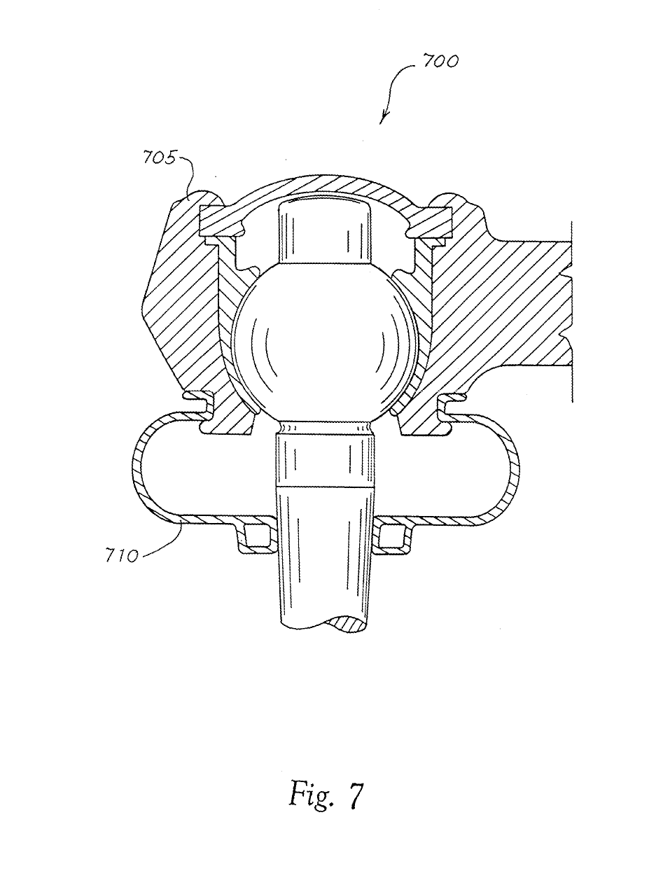

FIG. 7 depicts a ball joint 700 with seal 710, which may advantageously prevent dirt, moisture, and other contaminants from entering housing 705. Ball joint 700 is depicted at zero degrees oscillation in FIG. 7.

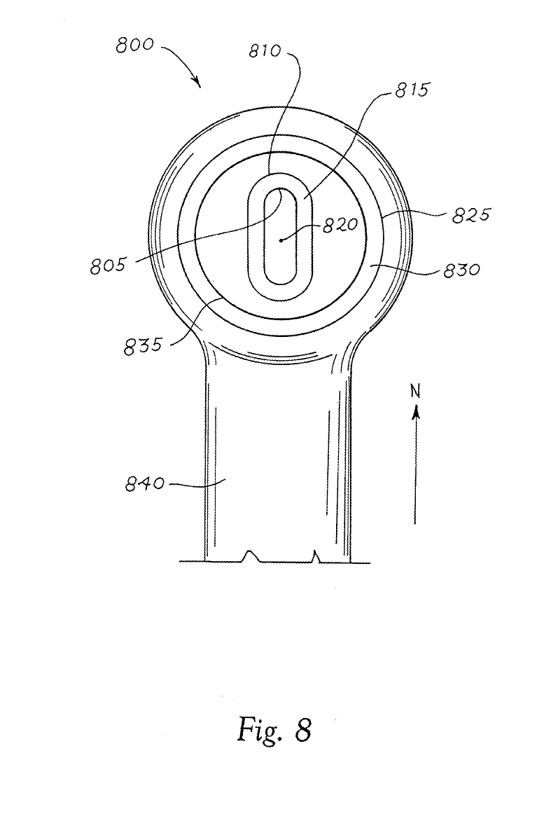

FIG. 8 depicts ball joint housing 800. A passage is defined by curves 805 and 810, and sidewall 815. The passage may be an opening or a channel. If the passage is an opening, then area 820 designates an opening from the inside of ball joint housing 800 to outside of ball joint housing 800. If the passage is a channel, then area 820 designates a bottom surface of a groove in the housing. The passage may be formed in ball joint housing 800, or may be formed in a cap, which is then fastened or fitted to ball joint housing 800.

Ball joint housing 800 may also comprise an opening to accommodate a ball shaft. Curves 825 and 835, and sidewall 830 may define the opening that accommodates the ball shaft.

Ball joint housing 800 may be used in a ball joint to restrict the maximum oscillation of the ball joint. More particularly, a ball stud may be attached to or formed with a ball head. A ball shaft is attached to or formed with the ball head on the side opposite the ball stud. The ball head may be placed into ball joint housing 800 to create a ball joint. By restricting the lateral movement of the ball stud, sidewall 815 may restrict the maximum oscillation of the ball joint created from ball joint housing 800. For example, sidewall 815 may prohibit the ball joint from oscillating east and west, while permitting the ball joint to oscillate north and south, where the compass directions refer to the arrow designating north as “N” in FIG. 8. Sidewall 830 may not influence the maximum oscillation because of its circular shape and size relative to sidewall 815. Ball joint housing 800 may also include armature 840, which may be used to mount ball joint housing 800, for example, to a vehicle's steering system or suspension system.

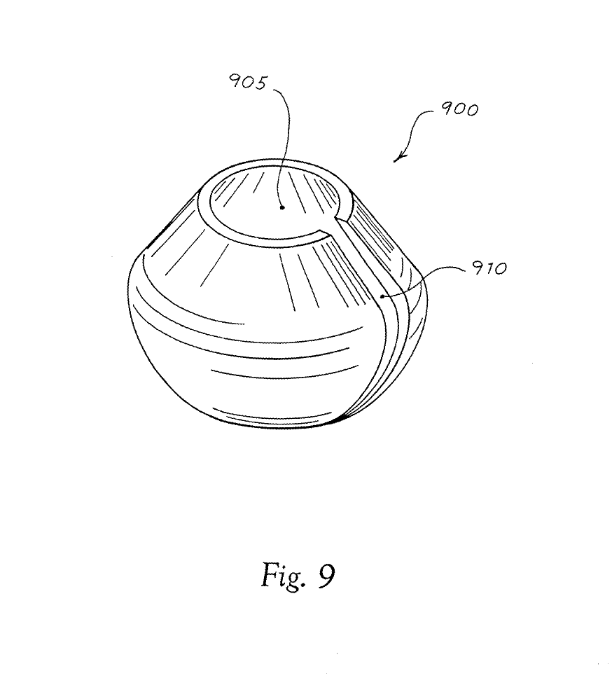

FIG. 9 depicts ball race 900. Ball race 900 may be fitted between the inner surface of a ball joint housing and a ball head. Ball race 900 includes slot 910 and opening 905. A second opening (not shown) may be opposite opening 905. Ball race 900 may be metal, e.g., steel or bronze, or may be plastic, e.g., PEEK. Ball race 900 may advantageously reduce noise and/or increase the lifetime of a ball joint. Ball race may be constructed from a friction-reducing material, for example, to improve performance by decreasing wear and tear, heat production, noise, and sluggish response of a vehicle's handling.

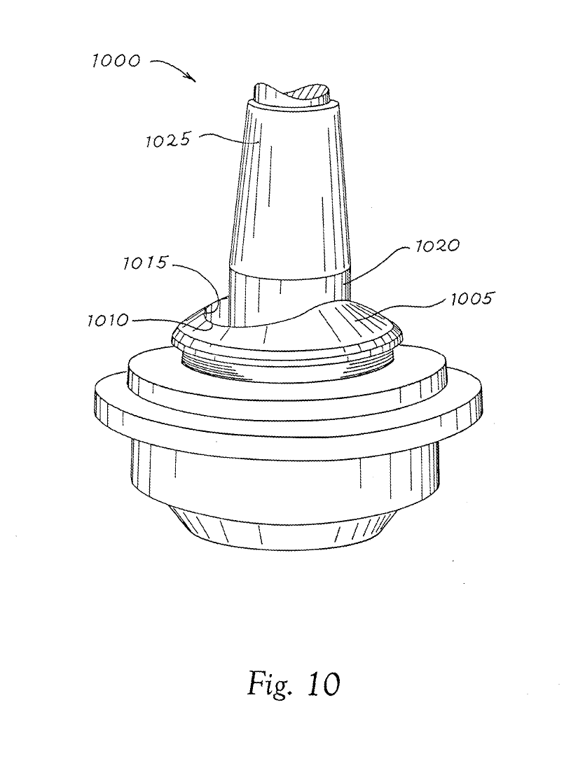

FIG. 10 depicts ball joint 1000. Housing 1005 includes an opening which is defined by curve 1010 and sidewall 1015. The edge of sidewall 1015 opposite curve 1010 is not shown, but may be situated proximate to the ball head (not shown). Ball shaft 1025 is connected to the ball head and extends through the opening in housing 1005. Neck 1020 of ball shaft makes contact with sidewall 1015 when the ball joint is at maximum oscillation. Sidewall 1015 may restrict the ball joint to maximum oscillations of varying amounts depending on the direction of oscillation.

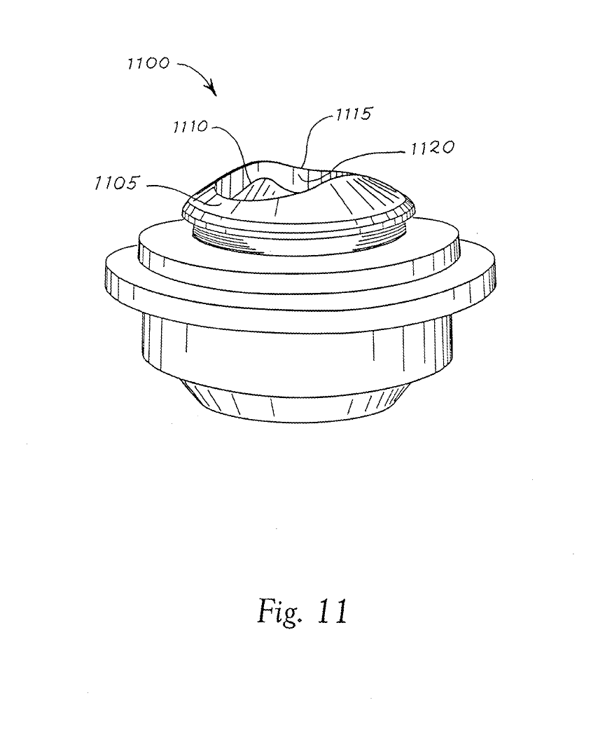

FIG. 11 depicts housing 1100 that may be used, for example, in ball joint 1000 of FIG. 10. Component 1105 of housing 1100 includes an opening to accommodate a ball shaft. The opening is defined by curves 1110 and 1115, and sidewall 1120 between curves 1110 and 1115. Curves 1110 and 1115 may be circular, non-circular, oval, non-planar, planar, different from each other, or the same as each other. Curves 1110 and 1115 may also have the same shape, but one curve may be a scaled version of the other. For example, curve 1110 may have the same shape as curve 1115, but curve 1110 may be seventy-five percent of the size of curve 1115. Curves 1110 and 1115 may be three dimensional curves. For example, curves 1110 and 1115 depicted in FIG. 11 are three dimensional curves. Housing 1100 may be used in a restrict ball joint, in which a ball shaft's movement is restricted by sidewall 1120.

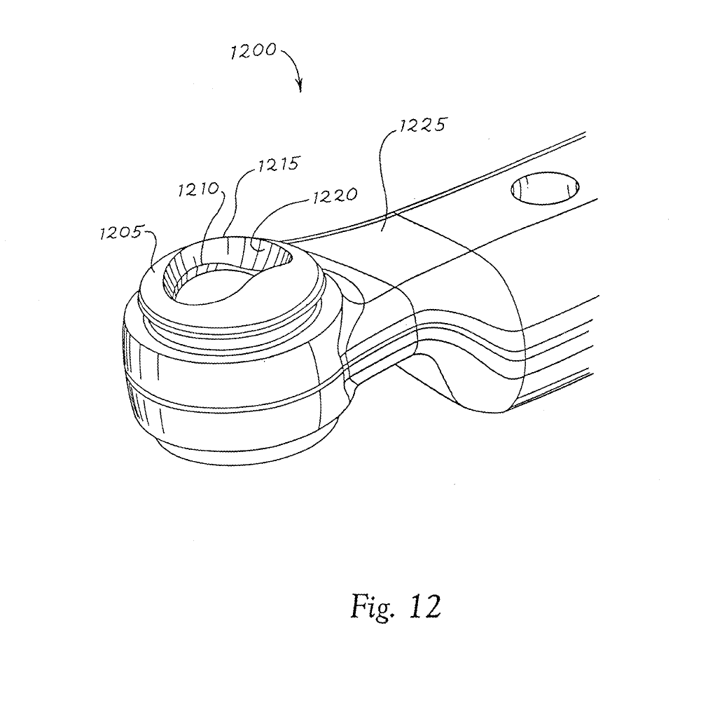

FIG. 12 depicts ball joint housing 1200. Component 1205 of housing 1200 includes an opening to accommodate a ball shaft. Component 1205 may be integral to ball joint housing 1200, or may be attached to ball joint housing 1200 using threads or welds. Component 1205 may be replaceable. The opening in component 1205 is defined by curves 1210 and 1215, and sidewall 1220. Ball joint housing may be used in a restricted ball joint because sidewall 1220 may restrict the maximum oscillation of a ball shaft. Armature 1225 may provide a means of connected ball joint housing 1200 to a larger system, for example, a mechanical system in a vehicle or other machine.

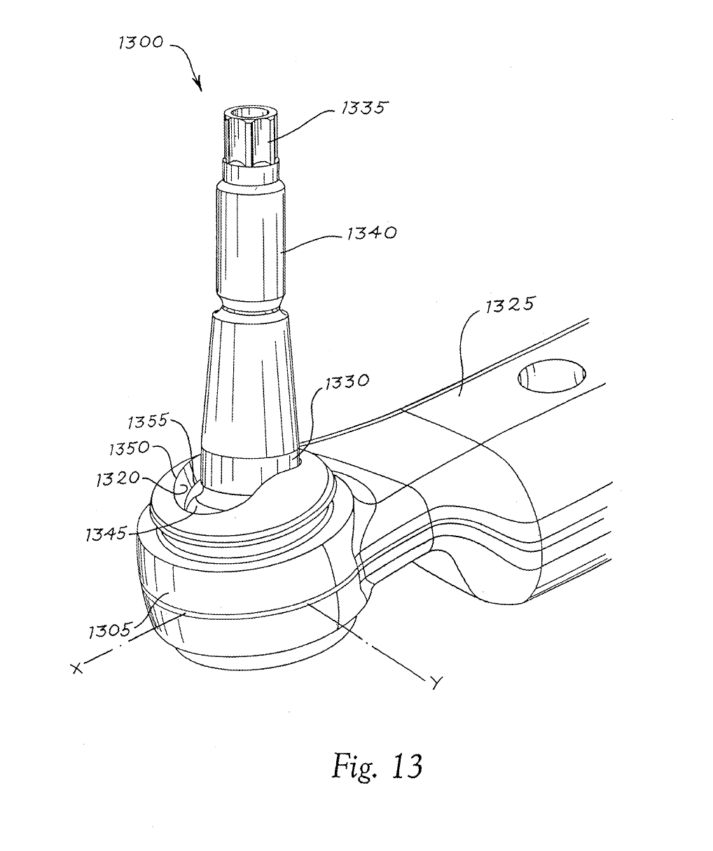

FIG. 13 depicts ball joint 1300. Ball head 1345 is fitted within housing 1305, which includes an opening to accommodate ball shaft 1340. The opening in housing 1305 is defined by curves 1355 and 1350, and sidewall 1320. Sidewall 1320 prevents neck 1330 of ball shaft 1340 from moving past a maximum point of oscillation. Thus, ball head 1345 is restricted in how far it may rotate in housing 1305. Ball joint 1300 also includes connecting end 1335, which may connect with other mechanical components in a larger system, for example, a vehicle steering and suspension system.

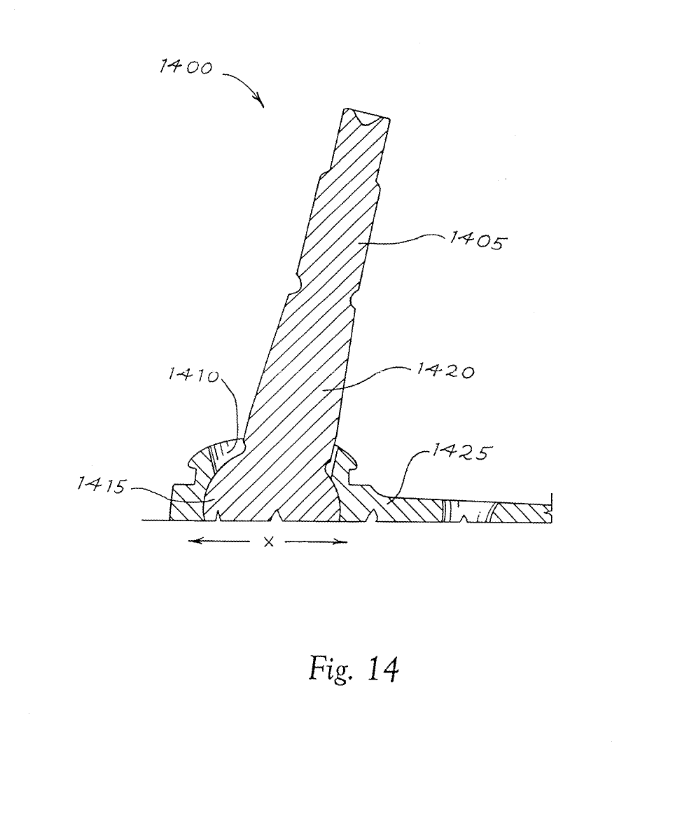

FIG. 14 depicts a side cutaway perspective of ball joint 1300 in FIG. 13 along the X-axis referred to in FIG. 13. Ball shaft 1405 extends from ball head 1415, which is rotatably fitted in housing 1425. Neck 1420 of ball shaft 1405 makes contact with sidewall 1410 when the ball joint is at maximum oscillation in the direction of the X-axis. Thus, sidewall 1410 restricts ball joint 1300 in the X-axis to a set angle, i.e., a maximum oscillation. The maximum oscillation in the direction of the X-axis may be set by configuring the shape and angle of sidewall 1410.

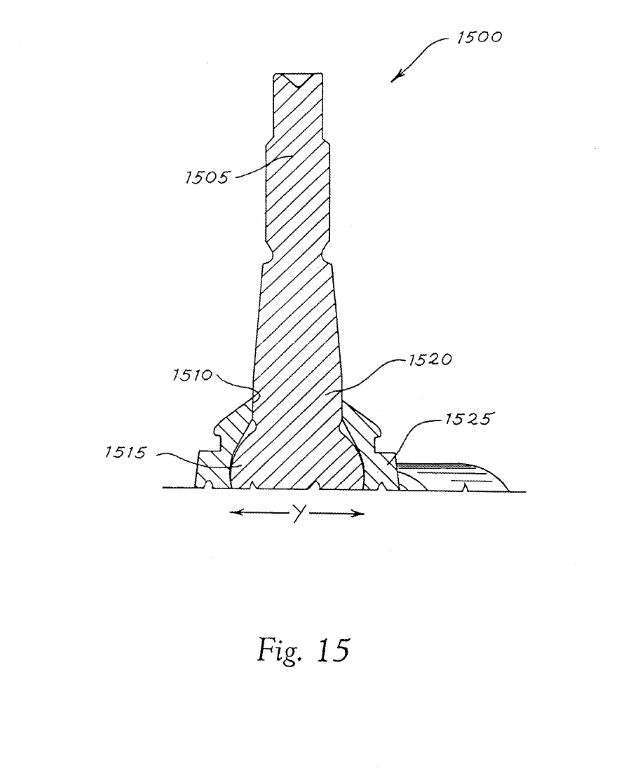

FIG. 15 depicts a side cutaway perspective of ball joint 1300 in FIG. 13 along the Y-axis referred to in FIG. 13. Ball shaft 1505 extends from ball head 1515, which is rotatably fitted in housing 1525. Neck 1520 of ball shaft 1505 makes contact with sidewall 1510 when the ball joint is at maximum oscillation in the direction of the Y-axis. In FIG. 15, sidewall 1510 has been designed such that it prevents no oscillation in the direction of the Y-axis. This restriction may advantageously prevent tie rod flop where no oscillation is necessary in the direction of the Y-axis, but oscillation is necessary in the direction of the X-axis. The maximum oscillation in the direction of the Y-axis may be set by configuring the shape and angle of sidewall 1510.

For ball joint 1300 in FIG. 13, it is possible to adjust the characteristics of sidewall 1320 to restrict the maximum oscillation of ball joint 1300. It may be seen from the cutaway FIGS. 14 and 15 how sidewall 1320 (represented by sidewall 1410 in FIG. 14 and sidewall 1510 in FIG. 15) may be used to control the restrictions of ball joint 1300.

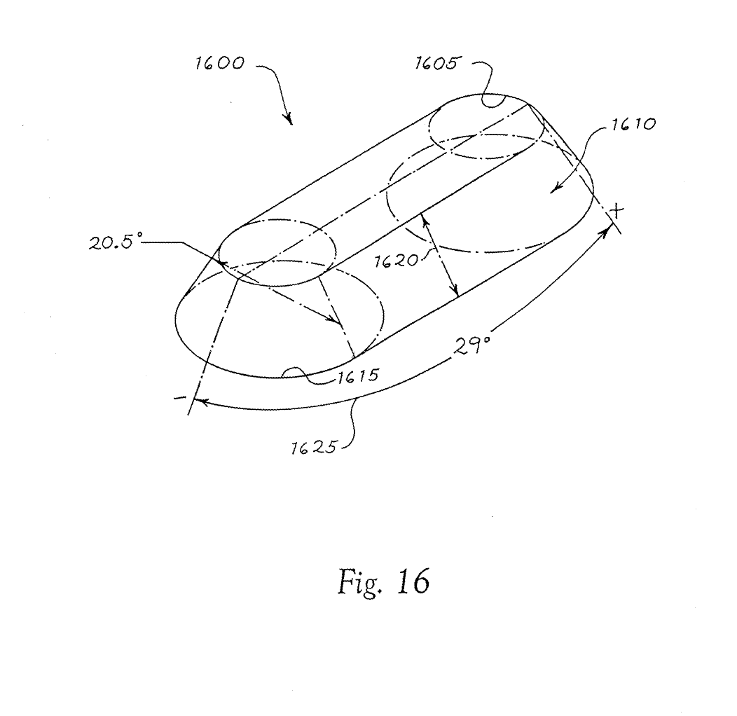

FIG. 16 illustrates a drawing of passage 1600 that may be part of a restricted ball joint. The shape of passage 1600 is defined by sidewall 1610. Sidewall 1610, in turn, is defined by curve 1605, curve 1615, and the area between curves 1605 and 1615. The area is dependent on the distance between curves 1605 and 1615. In passage 1600, curves 1605 and 1615 lie in parallel planes. Distance 1620 is the distance between the parallel planes that contain curves 1605 and 1615. Alternatively, curves 1605 and 1615 may lie in non-parallel planes, or, curve 1605 and/or curve 1615 may be non-planar. Surface 1610 restricts the maximum oscillation of the ball joint by prohibiting a member, for example, a ball shaft or a ball stud, from moving past a certain angle of rotation. Angle 1625 depicts the total maximum oscillation permitted by passage 1600 in a direction along the longer dimension of passage 1600. The angle indicated by “20.5°” in FIG. 16 depicts the total maximum oscillation permitted by passage 1600 in a direction along the shorter dimension of passage 1600. Passage 1600 may provide an asymmetrical restriction for the oscillation range of angle 1625. The maximum oscillation in the direction towards the “−” from zero degrees (i.e., perpendicular to the planes of curves 1605 and 1615) may be greater than the maximum oscillation in the direction towards the “+” from zero degrees. The maximum oscillation of a ball joint may be asymmetrical in all or some directions of movement. Alternatively, the maximum oscillation of a ball joint may be symmetrical in all or some directions of movement.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A ball joint comprising:
a housing comprising:
an inner surface;
an outer surface; and
a passage extending through the inner surface;
a ball head rotatably fitted within the inner surface; and
a member connected to, and extending axially from, the ball head at least partially through the passage, the passage comprising:
a sidewall defined by a first curve proximate to the ball head, a second curve distal from the ball head, and an area between the first curve and the second curve that restricts the lateral movement of the member,
wherein the first curve and the second curve are closed curves having non-constant distance from the center of the curve to the points of the curve, and wherein the circumference of the first curve is different from the circumference of the second curve.

2. The ball joint of claim 1 wherein the passage is an opening, and wherein the member is a shaft extending through the opening.

3. The ball joint of claim 2 further comprising a sealing boot attached to the outer surface and at a point along the shaft on the opposite side of the opening from the inner surface.

4. The ball joint of claim 1 wherein the housing further comprises a ball race fitted between the inner surface and the ball head, and wherein the ball race extends along the inner surface and surrounds the ball head.

5. The ball joint of claim 4 wherein the ball race is made substantially from plastic.

6. The ball joint of claim 4 wherein the ball race comprises an opening on a first end and a slot extending from the opening towards a second end.

7. The ball joint of claim 6 wherein the opening is a first opening, and the ball race further comprises a second opening on the second end.

8. The ball joint of claim 7 wherein the slot extends from the first opening to the second opening.

9. The ball joint of claim 1
wherein the passage is a first passage and the housing further comprises a cap that is removably attached to the housing; and
a second passage that extends at least partially into the inner surface and forms a channel between the ball head and the cap.

10. The ball joint of claim 9 wherein the member is a stud extending at least partially into the channel.

11. The ball joint of claim 1 wherein the housing further comprises a channel that extends at least partially into the inner surface and the member is a stud extending at least partially into the channel,
the ball joint further comprising a shaft connected to, and extending axially from, the ball head and through the passage.

12. The ball joint of claim 11 wherein the shaft extends axially from the ball head in a direction that is 180 degrees from a direction of extension of the stud from the ball head.

13. The ball joint of claim 1 wherein the sidewall is made substantially from a material selected from a group consisting of the following:
steel;
plastic;
bronze; and
polyether ether ketone (PEEK); and
wherein the member is composed of a material selected from a group consisting of the following:
steel;
plastic;
bronze; and
polyether ether ketone (PEEK).

14. The ball joint of claim 1 further comprising a shaft connected to, extending axially from, the ball head.

15. A ball joint comprising:
a housing;
a ball head rotatably fitted within the housing; and
a shaft connected to, and extending axially from, the ball head through an opening in a first end of the housing, the opening comprising:
a sidewall defined by a first curve proximate to the ball head, a second curve distal from the ball head, and an area between the first curve and the second curve that restricts the lateral movement of the member,
wherein the first curve and the second curve are closed curves having non-constant distance from the center of the curve to the points of the curve, and wherein the circumference of the first curve is different from the circumference of the second curve.

16. The ball joint in claim 15 wherein the first curve is substantially an oval in a first plane and is symmetric about a first axis in the first plane; and wherein the second curve is substantially an oval in a second plane and is symmetric about a second axis in the second plane.

17. The ball joint in claim 16 wherein the first plane is parallel with the second plane and the first axis is colinear with second axis.

18. A ball joint comprising:
a housing;
a ball head rotatably fitted within the housing;
a shaft connected to, and extending axially from, the ball head through an opening in a first end of the housing; and
a stud connected to, and extending axially from, the ball head, and extending axially from the ball head at least partially into a channel, the channel formed by a sidewall in the housing;
wherein the sidewall is defined by a first curve proximate to the ball head, a second curve distal from the ball head, and an area between the first curve and the second curve that restricts the lateral movement of the member, and
wherein the first curve and the second curve are closed curves having non-constant distance from the center of the curve to the points of the curve, and wherein the circumference of the first curve is different from the circumference of the second curve.

19. The ball joint in claim 18 wherein the first curve is substantially an oval in a first plane and is symmetric about a first axis in the first plane; and wherein the second curve is substantially an oval in a second plane and is symmetric about a second axis in the second plane.

20. The ball joint in claim 19 wherein the first plane is parallel with the second plane and the first axis is colinear with second axis.
